(19) United States
(12) Patent Application Publication
(10) Pub. No.: US 2007/0005676 A1
(43) Pub. Date: Jan. 4, 2007

(54) Simple and amended saturation for pipelined arithmetic processors

(76) Inventor: Matthew R. Henry, Fogelsville, PA (US)

Correspondence Address: VOLENTINE FRANCOS & WHITT, PLLC.;One Freedom Square, Suite 1260, 11951 Freedom Drive, Reston, VA, 20190, US

(21) Appl. No.: 11/169,867

(22) Filed: Jun. 29, 2005

(51) Int. Cl. G06F 7/38

(52) U.S. Cl. 708/552

(57) ABSTRACT

A method and apparatus to substantially prevent overflow in microprocessors are described.

Microprocessors are ubiquitous in today's world, finding applications from sophisticated computer and communication systems to childrens' toys. One type of microprocessor is a digital signal processor (DSP). A DSP is a microprocessor specifically designed for processing digital signals. With the proliferation of digital circuits and applications utilizing digital processing, DSPs are used in many different digital applications. Recently, DSPs have been developed which incorporate dedicated hardware accelerators to perform tasks that are normally MIPS (millions of instructions per second).

While DSPs have provided improved information processing speeds, there remains further demand to improve the processing speed of DSPs and microprocessors in general. One shortcoming of known DSPs results from overflow during calculations. Signed fixed-point digital addition and subtraction can overflow the designated numerical representation. For example, an N-bit signed number system generally encompasses numbers in the range of −2^{N-1} to 2^{N-1} −1. After attaining the highest possible number (maximum positive/minimum negative), the number ‘wraps around’ to the minimum negative or maximum positive number, depending on the numbers. As can be appreciated, overflow can be deleterious to the accuracy of the microprocessor.

One way to address overflow in critical paths of a microprocessor is to saturate a result that would otherwise overflow. Saturation is a technique whereby a maximum positive or a minimum negative is assigned to a number that overflows. Accordingly, saturation prevents conditions where a computation would result in overflow by clipping the result. As can be appreciated, saturation results in some inaccuracy in processor computation, but can prevent overflow of numbers in a continuum, and thereby prevent even more significant processor errors. Furthermore, arithmetic results often become operands of another calculation. As such, a saturated result is often used recursively. While the use of a saturated result is not ideal, it is a better alternative than use of an overflow result.

Many known methods for saturating results in processors results in significant propagation delays incurred for arithmetic functions, which can directly limit the operating frequency of the DSP or microprocessor.

There is a need for a saturation method and apparatus that overcomes at least the shortcomings described above.

### SUMMARY

In an example embodiment a method includes providing a first operand and a second operand. The method also includes performing an arithmetic operation on the first and second operands. In parallel with performing the arithmetic operation, the method includes predicting whether and overflow will occur based on the first and second operands.

In another example embodiment, an arithmetic and logic unit (ALU) includes an arithmetic unit adapted to perform an arithmetic function. The ALU also includes an amended saturation detection unit a saturation prediction unit and a Boolean logic unit.

In yet another example embodiment, a method includes providing a first operand and a second operand. The method also includes performing an arithmetic operation on the first operand and on the second operand to obtain an arithmetic result. In addition, the method includes providing an amended arithmetic result if the arithmetic result overflows.

### BRIEF DESCRIPTION OF THE DRAWINGS

The example embodiments are best understood from the following detailed description when read with the accompanying drawing figures. Wherever applicable and practical, like reference numerals refer to like elements.

FIG. 1 is a simplified block diagram of a digital signal processor (DSP) in accordance with an example embodiment.

FIG. 2A is a simplified schematic diagram of an ALU in accordance with an example embodiment.

FIG. 2B is a simplified schematic diagram of an ALU in accordance with an example embodiment.

FIG. 3a is a tabular representation used to predict saturation in accordance with an example embodiment.

FIG. 3b is a tabular representation used to predict saturation in accordance with an example embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

Specific details will now be set forth with respect to example embodiments depicted in the attached drawings.

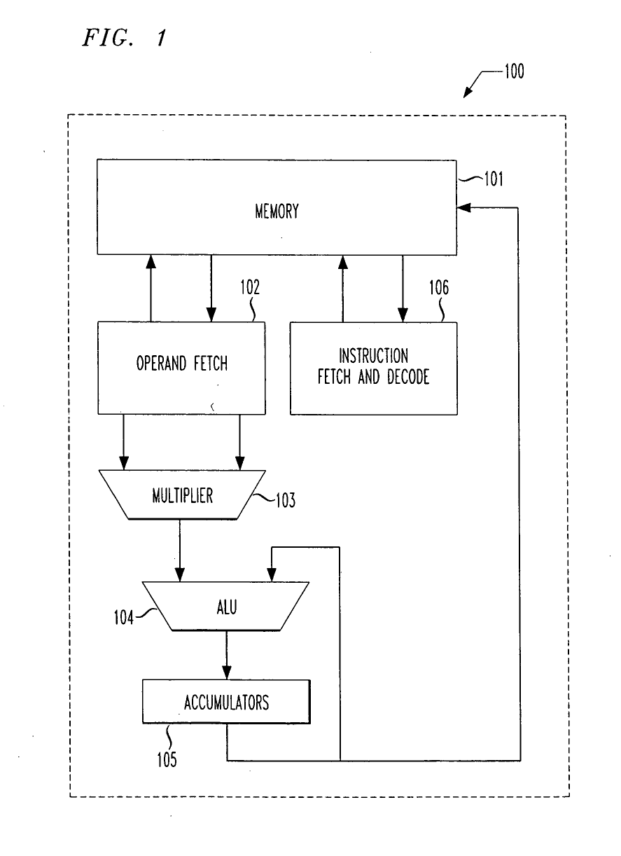

FIG. 1 is a simplified block diagram of a DSP 100 in accordance with an example embodiment. The DSP of the example embodiment includes a memory 101. The memory 101 is coupled to an operand fetch unit 102, which is adapted to provide and retrieve operands from the memory. In addition, an instruction fetch and decode unit 106 is coupled to the memory. The operand fetch unit 102 is coupled to a multiplier 103, which is in turn coupled to an ALU 104. The ALU 104 of example embodiments is described in greater detail herein.

The output of the ALU is provided to accumulators 105, which are a series of registers. As is known, the function of the ALU 104 is often recursive in nature, with the output of one arithmetic operation performed in the ALU 104 being an operand of a subsequent operation. As such, some or all of the output of the accumulators 105 may be fed back into the ALU 104 as shown. Alternatively, some or all of the output of the accumulators may be provided to the memory 101.

The processed data from the memory 101 may then be provided to a bus or other communication link (not shown), or may be further processed by the DSP 100, or both. Notably, many of the elements of the DSP 101 and their function are known to one of ordinary skill in the art, and may be implemented in known hardware and software. Details of these elements and their function are not provided so as to avoid obscuring the description of the example embodiments.

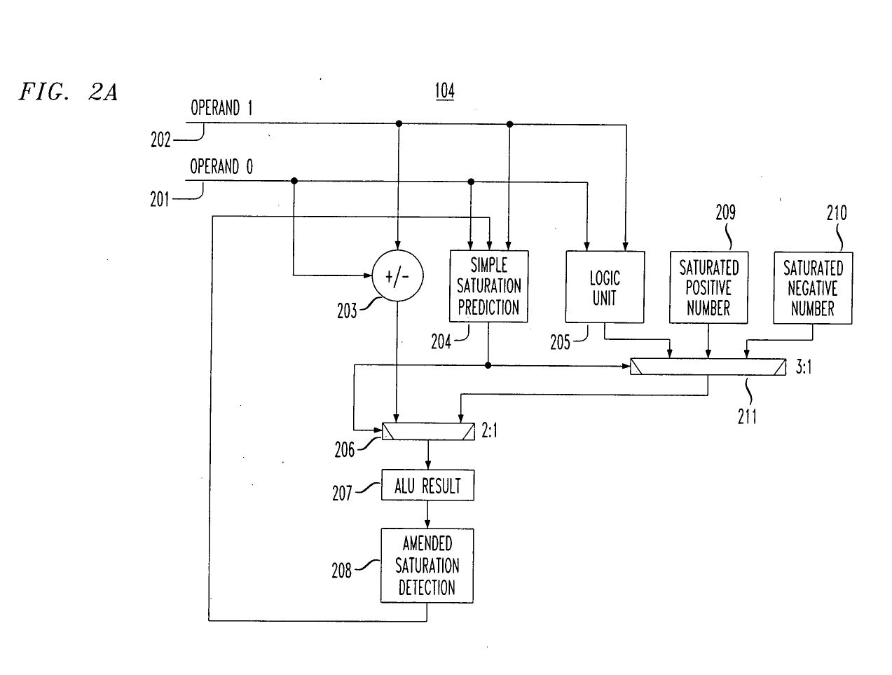

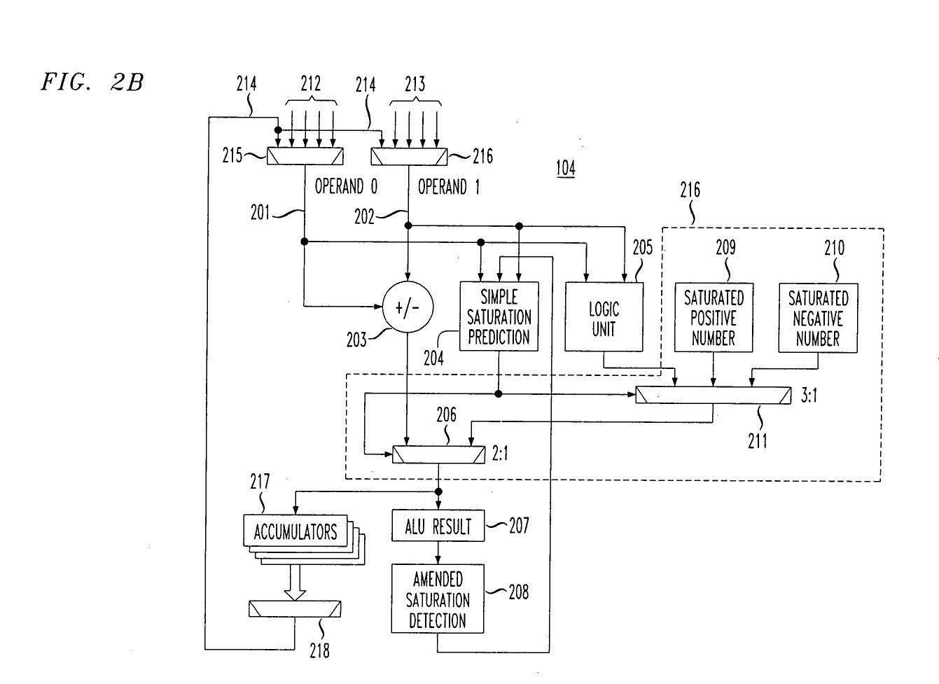

FIG. 2A is a simplified schematic diagram of the ALU 104 in accordance with an example embodiment. An instruction from the memory 101 presents a first operand 201 (operand 0) and a second operand 202 (operand 1). The operands 201, 202 are input in parallel to an arithmetic unit (e.g., an adder/subtractor) 203; to a simple saturation prediction unit 204; and to a logic unit 205. Notably, the processing of two operands is merely illustrative and it is emphasized that the present teachings may be applied to more operands than two.

As described in specific detail herein, the ALU 104 substantially prevents overflow and saturates certain results. Saturating a result first requires an overflow of the positive or negative bounds set for the DSP 100. Such overflow could occur as a result of the arithmetic function of the arithmetic unit 203. If overflow is detected, the ALU 104 selects a saturated result to replace the sum or difference that would overflow.

Beneficially, the ALU 104 minimizes propagation delay of the detection of a saturation condition by predicting the saturation in parallel with the function of the arithmetic unit 203, or by deferring the substitution of a saturated result to the next propagation cycle. This deferral of the substituted saturated result stalls the arithmetic pipeline of the DSP 100 for one clock cycle.

In any given clock cycle, neither of the operands 201, 202 may be saturated in keeping with the number system of the DSP 100. Alternatively, one or both of the operands may be saturated. The application and benefits of the ALU 104 of the example embodiment is described presently for unsaturated and saturated operands.

Each operand 201, 202 is provided to the arithmetic unit 203, the simple saturation prediction unit 204 and the logic unit 205. If neither the first operand 201 nor the second operand 202 meets the bounds of the number system of the DSP 100 (i.e., is itself saturated), the ALU 104 does not attempt to predict saturation. After the arithmetic unit 203 performs the instructed function on the first and second operands 201, 202, the result is output to a 2:1 multiplexer (mux) 206. In this case the simple saturation prediction unit 204 instructs the mux 206 to pass the result from the arithmetic unit 203 to an ALU result register (accumulator) 207. The arithmetic result, which does not exceed the bounds of the number system of the DSP 100, is then passed through to an amended saturation detection unit 208. The amended saturation detection unit 208 takes no action when the ALU result register 207 does not overflow.

Illustratively, the ALU result register 207 may be one of a plurality of registers/accumulators. As detailed herein, the amended saturation 208 is a combinatorial function that detected overflow in-line via saturation logic known to those skilled in the art.

Alternatively, the arithmetic result of the arithmetic unit 203 can overflow the bounds of the number system of the DSP 100, resulting in deleterious wrap-around. In the present example embodiment, the overflow was not predicted. As such, the simple saturation prediction unit 204 again instructs the mux 206 to pass the arithmetic result to the ALU result register 207. The ALU result register 207 then passes the result to the amended saturation detection unit 208, which decodes the arithmetic result. The amended saturation detection unit 208 then stalls the arithmetic pipeline for one clock cycle and instructs the simple saturation detection unit 204 to pass the maximum positive (saturated positive) or minimum negative (saturated negative) value as the arithmetic result rather than the actual result, which is an overflow.

The stalling sequence places the DSP pipeline, up to and including the operands that feed the ALU, in a dormant or hold-state for one cycle. As such, during this stalled cycle, instructions do not advance through the arithmetic pipeline, allowing the ALU 104 to amend the saturated result.

The saturated value is registered in the ALU result register 207 or in another accumulator (not shown) in the same manner as the original (overflow) result. The saturated value replaces the overflow result in that particular register/accumulator.

The amended saturation detection unit 208 may be an overflow detector known to one of ordinary skill in the art. The amended saturation detection unit 208 may use guard bits to determine the presence of a result that will not fit in the DSP precision or within the metes and bounds of the DSP number system. Alternatively, the unit 208 may perform a lookup function of operand signs, result signs and addition/subtraction to determine that an overflow result has an unexpected sign.

Because of the recursive and often iterative nature of the arithmetic calculations of many DSPs and microprocessors, this amended saturated arithmetic result may be recirculated and become an operand (e.g., operand 201, or operand 202, or both) of a subsequent arithmetic computation by the arithmetic unit 203. As detailed herein, the simple saturation prediction unit 204 decodes this operand and may select a saturated value for subsequent arithmetic calculations based on certain rules of an example embodiment.

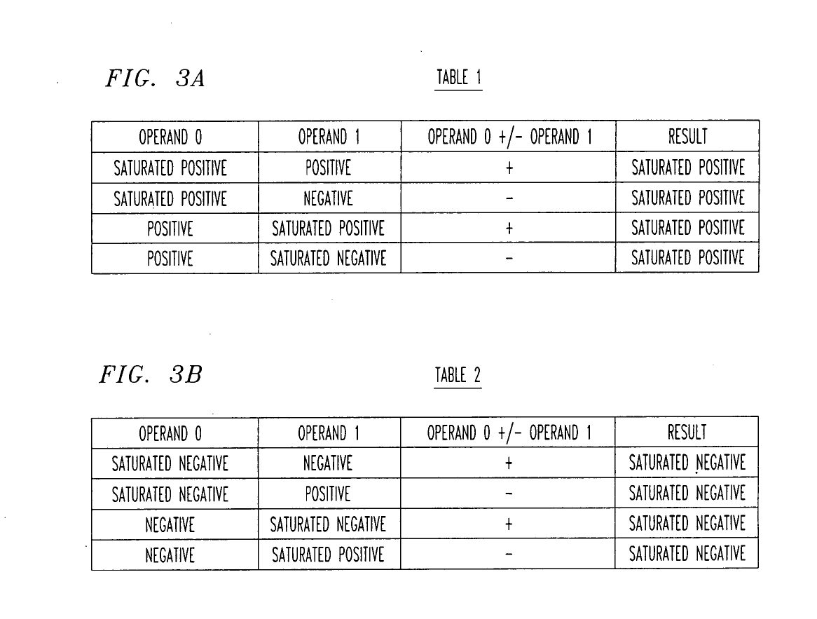

If one or more of the first and second operands 201, 202 are saturated, the simple saturation detection unit 204 predicts whether subsequent arithmetic computations of the arithmetic unit 203 will produce a saturated result. In an example embodiment, Table 1 and Table 2 of FIGS. 3a and 3b, respectively, are used by the unit 204 to predict saturation.

In a specific embodiment, the simple saturation detection unit 204 combinationally decodes the criteria for simple saturation according to the rules of Tables 1 and 2. These criteria result in the taking of no action, or the substitution of saturated positive or saturated negative values if overflow conditions are not met. To wit, if the criteria for simple saturation are met, the simple saturation prediction unit 204 selects either the maximum positive or the minimum negative value to register as the result. In the ALU 104 of FIG. 2, this selection is carried out in parallel with the calculation by the arithmetic unit 203.

At the same time, the logic unit 205 performs Boolean logic functions on the first and second operands 201, 202 and the result is multiplexed with the saturated positive number 209 and the saturated negative number 209 at a 3:1 mux 211. The output of the mux 210 is input to the mux 206.

Notably, the ALU 104 generally performs either an arithmetic function or a Boolean logical function. The presence of the logic unit 205 in the present embodiment illustrates the manner in which the ALU selects an arithmetic or logical result. Because the propagation delay associated with the logical result is much less than that associated with the arithmetic result, maximum positive and minimum negative values multiplex with the logical result to avoid virtually any delay penalty to the overall ALU structure.

In the event that the simple saturation prediction unit 204 determines that the conditions of saturation are met, the unit 204 instructs the mux 206 to pass the output of the mux 211, which is the appropriate saturated number, to the ALU result register 207. In the event that the simple saturation prediction unit 204 determines that the conditions for saturation are not met, the unit 204 instructs the mux 206 to pass the arithmetic result from the arithmetic unit 203 to the ALU result register.

The conditions for saturation take into account the value of each operand 201, 202, the sign of each operand 201, 201 and the arithmetic function of the arithmetic unit 203 as noted in Tables 1 and 2. For purposes of illustration, suppose the first operand 201 were a saturated positive value determined by the amended saturation detection unit 208 in a previous cycle. If the second operand is a positive number and the arithmetic function of the arithmetic unit 203 were addition, based on Table 1 the simple saturation prediction unit 204 would predict the result to be a saturated positive value of the number system of the DSP 100. Accordingly, the simple saturation prediction unit 204 instructs the mux 206 to pass the positive saturated value from the mux 211 to the ALU result register 207. Notably, the absence of the criteria set forth in Tables 1 and 2 translates into an ‘unsaturated’ result.

The ALU 204 described in connection with example embodiments either predicts if an overflow will occur, or amends the result of an overflow when saturation is not readily predicted. The former is carried out in parallel to the arithmetic calculation and thus incurs substantially no propagation delay. The latter requires only one clock cycle so an amended result may be provided to prevent computational errors because of overflow with insubstantial propagation delay.

FIG. 2B is a simplified schematic diagram of the ALU 104 in accordance with another example embodiment. The ALU 104 described in connection with FIG. 2B shares many common features, functions and components are the ALU described in connection with the example embodiment of FIG. 2A. Many of the details of these common features, functions and components are not repeated to avoid obscuring the description of the present embodiment. Notably, in the example embodiment of FIG. 2B, the functional operation of the ALU is substantially the same, but includes additional features described presently.

The ALU 104 is adapted to receive a plurality of operands 212, which are input to a multiplexer 215. The output of the mux 215 is the first operand 201 to the ALU for processing as described. The plurality of operands 212 includes operands from other sources of the DSP 100. In addition, the ALU is adapted to receive a plurality of operands 213, also from other sources of the DSP 100. A multiplexer 216 provides the second operand 202 as the output. As described more fully herein, an operand 214 is provided to the multiplexers 215, 216 and may be used as the amended saturated result in a subsequent operation.

The ALU 104 also includes a plurality of accumulators 217, which are adapted to receive the output of the multiplexer 206. The accumulators 217 provide results to a multiplexer 218, which in turn provides the operand 214 based on instructions received.

Logic element 216, comprising elements in the ‘dotted’ lines of FIG. 2B, is the data path that performs the simple or amended saturation as described previously. This logic element 216 may be duplicated for each of the accumulators 217 without adding significantly to the complexity or cost of the DSP 100. In an example embodiment, a plurality of the logic elements 216 is provided, one for each of the accumulators 217.

By providing a logic element 216 for each accumulator 217, the pipeline will only need to be stalled to amend the saturated result if the result of a particular accumulator 217 is being amended as the ALU operand in the next subsequent instruction. As a result, the logic element 216 allows amended saturation of one of the accumulators 217 concurrently with the use of results of other accumulators being the source and destination in subsequent instruction.

For example, suppose one of the accumulators 217 obtains a result in a cycle that is an overflow value, and suppose the result is not being used as an operand in the next cycle. In this case the respective logic element 216 for this accumulator 217 would amend the result to the appropriate saturated value according to the methods described previously with the example embodiment of FIG. 2A. The instruction from the DSP 100 may select a result from another accumulator 217 to become the operand 214 from the multiplexer 218. Alternatively, the ALU 104 may not be used by the DSP 100 in a cycle immediately following a saturated result. As such, there is no need to stall the pipeline to allow the ALU 104 to provide the amended saturated result as an operand or result for subsequent operations.

Alternatively, suppose one of the accumulators 217 obtains an overflow value in a cycle and the particular accumulator 217 is specified in an instruction to be used as one of the first or second operands 201, 202, in the next subsequent operation. In this case, the ALU pipeline stalls for one cycle to permit the result to be saturated and provided as an amended saturation result. To this end, if the result of the accumulator 217 to be used as the operand in the very next result is an overflow, the pipeline stalls for one cycle. The ALU result 207 is provided to the simple saturation predictor unit 204, which instructs the mux 211 to pass the appropriate saturated result to the mux 206. The mux 206 is similarly instructed to pass the saturated result to the particular accumulator 217. The saturated result is then provided as the operand 214 via the mux 218, where it becomes one or both of the operands 201, 202 in the next ALU operation.

Beneficially, the ALU 104 of the example embodiment of FIG. 2B allows the ALU to perform the amended saturation of an overflow result in parallel with other operation when the overflow result is of an accumulator that is not specified as one of the ALU operands 201, 202 in the very next operation. Thus, the frequency of stalling the pipeline may be reduced.

In view of this disclosure it is noted that various methods and components described in conjunction with an ALU of the example embodiments can be implemented in hardware. The present teachings are not limited to two operands, and may be readily extended to more than two operands. Furthermore, the various methods, devices and parameters are included by way of example only and not in any limiting sense. In view of this disclosure, those skilled in the art can implement the various example devices and methods in determining their own techniques and needed equipment to effect these techniques, while remaining within the scope of the appended claims.

1. A method, comprising:
providing a first operand and a second operand;
performing an arithmetic operation on the first operand and the second operand to obtain an arithmetic result; and
providing an amended arithmetic result if the arithmetic result overflows.

2. A method as recited in claim 1, wherein the amended arithmetic result is a positive saturated value.

3. A method as recited in claim 1, wherein the amended arithmetic result is a negative saturated value.

4. A method as recited in claim 1, further comprising substituting the amended arithmetic result in a subsequent step.

5. A method as recited in claim 1, wherein the arithmetic operation is addition, or subtraction, or both.

6. A method as recited in claim 1, further comprising:
in a subsequent clock cycle, predicting if an overflow will occur based on a saturated operand.

7. A method as recited in claim 1, wherein the providing the amended result further comprises stalling a pipeline for one cycle.

8. A method as recited in claim 1, wherein the providing the amended result further comprises:
providing an unsaturated result to an accumulator, wherein the unsaturated result is an operand in a next step;
amending an overflow result to a saturated value in parallel with the providing the unsaturated result; and
providing the amended saturated value to another accumulator, wherein a pipeline is not stalled for the amending.

9. A method, comprising:
providing a first operand and a second operand;
performing an arithmetic operation on the first operand and on the second operand to obtain an arithmetic result; and
in parallel with the performing, predicting if an overflow will occur based on the first operand and the second operand.

10. A method as recited in claim 9, further comprising providing a saturated value to a register if an overflow is predicted.

11. A method as recited in claim 10, wherein the saturated value is a positive saturated value.

12. A method as recited in claim 10, wherein the saturated value is a negative saturated value.

13. A method as recited in claim 10, wherein the saturated value is one of the first or second operands in a subsequent clock cycle.

14. A method as recited in claim 10, wherein the providing the amended result further comprises:
providing an unsaturated result to an accumulator, wherein the unsaturated result is an operand in a next step;
amending an overflow result to a saturated value in parallel with the providing the unsaturated result; and
providing the amended saturated value to another accumulator, wherein a pipeline is not stalled for the amending.

15. An arithmetic and logic unit (ALU), comprising:
an arithmetic unit adapted to perform an arithmetic function;
an amended saturation detection unit; and
a saturation prediction unit; and a Boolean logic unit.

16. An ALU as recited in claim 15, wherein the arithmetic unit is an adder/subtractor.

17. An ALU as recited in claim 15, further comprising an ALU result register and a plurality of accumulators.

18. An ALU as recited in claim 15, wherein the ALU further comprises at least one logic element adapted to provide an amended saturated result or a predicted saturated result.

19. An ALU as recited in claim 17, wherein the ALU further comprises a plurality of logic elements, each of which is coupled to a respective one of the accumulators.

20. An ALU as recited in claim 17, wherein the ALU is a component of a digital signal processor.
